(19) United States
(12) Patent Application Publication
(10) Pub. No.: US 2002/0116444 A1
(43) Pub. Date: Aug. 22, 2002

(54) Method and system for providing intelligent network content delivery

(76) Inventors: Imran Chaudhri, North Potomac, MD (US); Ken Lee, Oakton, VA (US); Kent Lockhart, Sterling, VA (US); Shan Jiang, Herndon, VA (US); Vishal Suri, Sterling, VA (US)

Correspondence Address: LAW OFFICES OF JONATHAN ALAN QUINE, P O BOX 458, ALAMEDA, CA, 94501

(21) Appl. No.: 09/728,428

(22) Filed: Dec. 1, 2000

Related U.S. Application Data
(60) Provisional application No. 60/186,054, filed on Feb. 29, 2000.

(51) Int. Cl. G06F 15/16

(52) U.S. Cl. 709/201

(57) ABSTRACT

Methods and systems for providing improved acceleration of network content using an intermediate node and/or dynamic translations are disclosed.

This application claims priority from provisional patent application No. 60/186,054 filed Feb. 29, 2000.

### FIELD OF THE INVENTION

The present invention relates to the field of accessing information. More specifically, the present invention is directed to methods and/or systems for accelerating content provided over a communications channel or network.

### BACKGROUND OF THE INVENTION

Familiarity with services provided by content distribution networks (CDNs) and network proxy caching, and techniques used therein, is characteristic of practitioners in the art and is presumed to understand particular aspects of the present discussion.

At the present time, CDN services are provided by a number of CDN companies, such as Akamai, Digital Island, Adero, and Mirror Image. Typically, each of these companies has a proprietary and private set of proxy content servers or sources (also referred to as cache sources or edge devices or edge caches) that are geographically distributed. As is known in the art, each of these companies provides a subscription-type service to publishers whereby these companies cache, in a distributed fashion, content from data publishers in order to make that content more quickly available to viewers. For the most part, it is a characteristic of the services provided by such companies that each service is autonomous and does not utilize the cache sources of other companies.

For example, if a web publisher such as www.publisher.com, signs up with a service such as Akamai, viewers attempting to access www.publisher.com content may be redirected to cache sources operated by Akamai. These users will not be redirected to cache sources in any other CDNs operated by other services, even if those other CDNs might provide faster access to a particular user. Generally, user access is provided to CDNs through a reassignment of an address provided by a domain name server (DNS). Related technology is provided by reverse proxy caching vendors such as Net Aps, Inktomi, or Cacheflow.

Furthermore, publishers generally are required to perform a number of steps to initiate CDN services. Publishers may have to run utilities to convert the URLs on all web pages the publishers desire to accelerate. Publishers also may need to establish acceleration policies according to specific formats specified by specific CDN services. In such cases, it is difficult for a publisher to use services from more than one CDN.

Various methods are used to provide CDN services. Some providers, such as Akamai, generally require a publisher to translate HTML pages at the publishers web site to include URLs indicating the CDN source for embedded content. Other CDN services, such as Digital Island or Adero, may cache some publisher HTML pages and use DNS redirection to reach the cache sources.

### SUMMARY

The present invention may be understood in the context of content publishers (or content providers) and content access over a communication media. An important application for the present 10 invention, and an independent embodiment, is in the field of serving content over the Internet using Internet multimedia protocols and formats, such as HTTP, RTTP, XML, HTML, VRML, as well as image, audio, or video formats etc. However, using the teachings provided herein, it will be understood by those of skill in the art, that the methods and apparatus of the present invention could be advantageously used in other related situations where users access content over a communication channel, such as cable television systems, wireless systems, etc.

The present invention involves a number of unique methods and/or systems that can be used together or independently to provide improved acceleration and/or content distribution of computer formatted content and/or related services. In one aspect, the present invention addresses the problem of how to deliver content more quickly and effectively, given that there are different CDN (Content Distribution Network) providers with different cache systems, different methods for translating or redirecting addresses (such as URLs) to indicate cached content, different requirements for establishing acceleration policies, etc. For a particular network access, a best-existing CDN may not be part of a particular system to which a publisher subscribes.

To address this problem, the present invention adds a management/intermediate function or module or system between various competing CDN systems and publishers. This function facilitates selection of a CDN or other communication network for viewer access, directs a viewer to that source, and provides updated content and policies to that source on behalf of the publisher. This functionality can alone provide greater acceleration performance and ease of use to publishers.

In specific embodiments, the present invention can be understood as proposing a new management function as illustrated in TABLE 2.

TABLE 1
Existing Relationships in Content Distribution Services

| Web Content | Content | Content |
|---|---|---|
| Creation | Hosting | Distribution |
| Yahoo/Disney | Digex | Uunet |
| NY Times/CNN | Exodus | Cidera |
| | Frontier | Internap |
| | | Akamai |
| | | Digital Island |
| | | Mirror Image |

TABLE 2
Content Distribution Services with Intelligent Content Management

| | | Intelligent | |
|---|---|---|---|
| Web Content | Content | Content | Content |
| Creation | Hosting | Management | Distribution |
| Yahoo/Disney | Digex | ← FASTTIDE → | Uunet |
| NY Times/CNN | Exodus | | Cidera |
| | Frontier | | Internap |
| | | | Akamai |
| | | | Digital Island |
| | | | Mirror Image |

A further advantage that will be understood from the teachings herein is that in specific embodiments, the present invention can make it both easier and quicker for a publisher to initiate acceleration services, even services using multiple CDNs. With current competing CDNs, a publisher may have to investigate different CDN performance and interface requirements, may have to variously modify the publisher's content, and if the publisher wishes to access multiple CDNs, may have to enter into multiple contracts. Using a system according to the invention, however, a publisher can, for example, make a minor change to his initial home page and the system of the present invention can do the rest.

In a further aspect, the invention can be viewed as involving a new business method for providing CDN services to publishers by establishing an intermediary between individual publishers and a number of CDN services and communication networks. In so doing, the invention provides a standard interface for content delivery, policy setting, and payments that a publisher can use to access various CDN systems and/or communication networks that may each have unique procedures for handling these functions.

Content Bridge

Various aspects of the present invention may be further understood by consideration of (and in contrast to) services being proposed by “Content Bridge.” After the conception and first priority filing of the present invention, an industry group called “Content Bridge” was announced (formally on Aug. 23, 2000) as an alliance of web delivery service providers. Content Bridge was founded primarily by Inktomi, a marketer of scalable Internet infrastructure software, and Adero, a provider of content distribution services. Content Bridge is intended to facilitate content delivery at the edge of participating networks through content peering, which is described as allowing content to be delivered in a way that benefits every participant in the content delivery process.

Content Bridge has proposed, in general terms, a coalition service that will operate as follows:

1. A content provider in the Content Bridge network sends revised content to a host or content delivery network provider (CDN).

2. The hosting/CDN provider alerts the Content Bridge operator (the organization responsible for reporting and financial services) that content has been changed.

3. The operator updates all CDN and ISP edge caches. To provide billing and reporting services, the operator collects ‘anonymized’ usage data from the edge caches, including such things as number of cache hits, average response time, number of bytes transferred for each URL, and, in some cases, cache misses.

4. Information can then be forwarded to content providers. Content providers may receive either summary data or detailed log files that can be used for clickstream analysis.

According to Content bridge, host services will maintain control over relationships with content providers. Hosts will earn incremental revenue for every cache hit using their existing edge cache infrastructure. Content Delivery Networks are promised to extend their networks by accessing edge caches in networks in which they do not already have a presence. Content Providers are promised to gain visibility and control over content in edge caches, improve content performance for end users by distributing more types of content into a greater number of edge caches, receive valuable information about content usage and performance, and deliver content reliably via a trusted end-to-end service. Content providers do not join Content Bridge directly; instead, they may sign up for Content Bridge services through their hosting or CDN provider.

While these announcements are ambitious goals, specific methods and technology has generally not been disclosed. As one industry newsletter commented on Aug. 24, 2000 (Cracks in Inktomi's Content Bridge? by Jason Krause, Industry Standard)

So far, no one knows much about Inktomi's new technology. “We saw very little of substance,” says Akamai spokesman Jeff Young. “Nothing [Content Bridge] announced is currently available . . . . Inktomi says the technology is in testing now on AOL's network and will go live in early fall . . . [and] says the system will work better with more partners, and that more partners will join during the months to come. But outsiders wonder if this coalition can hold itself together. Inktomi is borrowing its model from the early days of ISPs, when providers would exchange traffic with one another to decrease network congestion. But squabbles soon broke out over whether or how to charge for the service. The results were fragmentation and headaches.

“The problem with coalitions is that they tend to get fragmented,” says Abhi Chaki, director of business development with Edgix, a content-delivery company set to launch in a month. “This is the same model but on the content side. And they're going to need a whole lot more partners if they want to bridge the gap between the end user and the content. They're going to need a lot more ISPs.”

Content Bridge, while hoping to combine caching operations of different providers, is proposing and testing a model based on coalitions of CDNs and ISPs, under control of hosting services, not of publishers. A coalition model has proven difficult to operate in the past.

The invention and various specific aspects and embodiments will be better understood with reference to the following drawings and detailed descriptions. In different figures, similarly numbered items are intended to represent similar functions within the scope of the teachings provided herein. In some of the drawings and detailed descriptions below, the present invention is described in terms of the important independent embodiment of a system operating on a digital data network. This should not be taken to limit the invention, which, using the teachings provided herein, can be applied to other situations, such as cable television networks, wireless networks, etc. For purposes of clarity, this discussion refers to devices, methods, and concepts in terms of specific examples. However, the invention and aspects thereof may have applications to a variety of types of devices and systems. It is therefore intended that the invention not be limited except as provided in the attached claims.

Furthermore, it is well known in the art that logic systems and methods such as described herein can include a variety of different components and different functions in a modular fashion. Different embodiments of the invention can include different mixtures of elements and functions, and may group various functions as parts of various elements. For purposes of clarity, the invention is described in terms of systems that include many different innovative components and innovative combinations of innovative components and known components. No inference should be taken to limit the invention to combinations containing all of the innovative components listed in any illustrative embodiment in this specification. The functional aspects of the invention that are implemented on a computer, as will be understood from the teachings herein, may be implemented or accomplished using any appropriate implementation environment or programming language, such as C, C++, Cobol, Pascal, Java, Java-script, HTML, XML, dHTML, assembly or machine code programming, etc. All references, publications, patents, and patent applications cited herein are hereby incorporated by reference in their entirety for all purposes.

### BRIEF DESCRIPTION OF THE DRAWINGS

FIG. 1 illustrates a general method for providing content distribution network services to publishers.

FIG. 2 illustrates in more detail a method with additional optional details according to a further specific embodiment of the invention.

FIG. 3 is a block diagram showing a system operating according to a specific embodiment of the invention.

FIG. 4 illustrates a method of providing CDN services to a publisher from a number of distribution sites according to specific embodiments of the invention.

FIG. 5 illustrates steps involved in example content acceleration according to specific embodiments of the invention.

FIG. 6 illustrates a process of real-time performance measurements according to specific embodiments of the invention.

FIG. 7 is a block diagram showing a representative example logic device in which various aspects of the present invention may be embodied.

### DESCRIPTION OF SPECIFIC EMBODIMENTS

General Method According to General Embodiments of the Invention

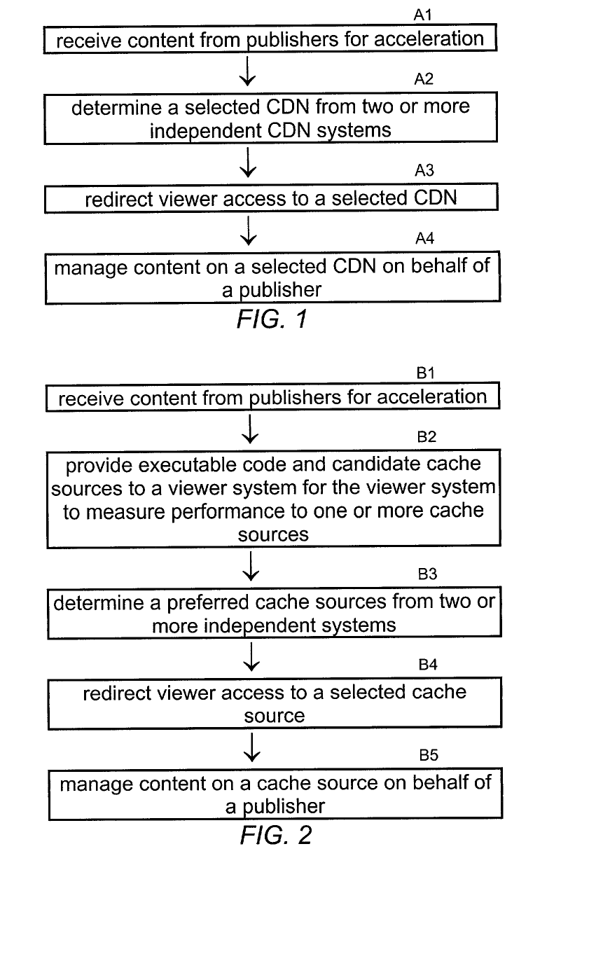

FIG. 1 illustrates a general method for providing content distribution network services to publishers. This method addresses the problem of how to deliver web content more quickly and effectively, given that there are different CDN providers with different cache systems or communication networks with different capabilities and that in typical publisher-CDN arrangements, a best-existing CDN may not be one to which a publisher subscribes.

To address this problem, the present invention adds a management function between various competing CDN systems and communication networks and publishers. This management function selects a CDN source for viewer access and directs the viewer to that CDN and, when necessary, provides updated content and policies to that CDN on behalf of the publisher. This management function alone can provide greater acceleration performance and ease of use to publishers. Selection of a CDN and performance of other caching functions can be according to any known method of performing these functions, such as statistical performance measures of CDNs.

In a further aspect, the invention can be viewed as involving a new business method for providing CDN services to publishers by establishing a management/payment intermediary between individual publishers and a number of independent CDN services. In so doing, the invention provides greater flexibility to publishers to, at different times and/or in different situations or circumstances, utilize CDN services from various independent providers. As will be understood from teachings herein, the invention can simplify publishers access to various CDN services by acting as a single source for managing acceleration policies, content distribution, and contract and payment arrangements. Thus, the invention can provide publishers with decreased effort in using caching services while providing greater performance.

FIG. 1 illustrates a general method as follows: receiving content and policies from publishers for acceleration (Step A1); determining a preferred CDN from two or more independent systems (Step A2); redirecting viewer access to a preferred CDN (Step A3); and managing content and policies and on said CDN on behalf of a publisher (Step A4).

Note that in this example method, publishers establish a relationship with a single acceleration service, which acts as the intermediary, and the intermediary handles relationships with one or more CDN services and distributes acceleration or distribution requests to available distribution sources (at times referred to in the industry as edge caches). In specific embodiments, these distribution sources can be a variety of edge cache systems in a variety of different CDNs and can also include systems directly owned and managed by the intermediary. Thus, there is no need for a coalition-type relationship among CDN or ISP hosting servers. The intermediary acts as the original publisher as far as competing CDNs are concerned, and the CDNs are paid by the intermediary for the aggregate services provided to the intermediary. The intermediary acts as a single CDN as far as publishers are concerned, and publishers can make a single arrangement with the CDN to initiate acceleration services and to set and manage acceleration policies. The intermediary is then responsible for translating acceleration policies to competing CDNs and to securing and managing service with different competing CDNs.

General Method Using Executable Code

As one example of how selection of a CDN can be accomplished, consider FIG. 2. FIG. 2 illustrates a general method according to further embodiments of the invention and illustrates receiving content and policies from publishers for acceleration (Step B1); providing executable code and data to a viewer system for the viewer system to measure performance to one or more CDNs (Step B2); determining a preferred CDN from two or more independent systems (Step B3); and managing content and policies and on a CDN on behalf of a publisher (Step B4).

Note that in this example system, the problem of selecting among various independent CDNs is addressed by using a performance measure experienced by a requesting client as a parameter to guide in selection of a particular CDN source. While other parameters, such as varying CDN service costs, can be used in selecting a CDN for servicing a particular request, including an objective measure of competing CDN service performance provides is a way to guarantee to publishers that they are getting the best available service.

The present invention has thus far been described in terms of general embodiments. The previous description is believed to be a full and complete description sufficient to allow a practitioner in the art of content acceleration and caching to make and use the invention. It will be understood to those of skill in the art from the teachings provided herein that the described invention or components thereof can be implemented in a wide variety of specific programming environments and logical systems (such as UNIX, Windows, Solaris, Oracle, etc.) using a wide variety of programming languages (such as SQL, Visual Basic, Pascal, C++, Basic, Java, JavaScript, etc.) and wide variety of file formats.

What follows are descriptions of example systems and methods that embody various aspects of the present invention. This following discussion is included, in part, in order to disclose particularly preferred modes presently contemplated for practicing the invention. The following discussion may also include independent innovative embodiments of the invention. It is intended, however, that the previous discussion and the claims not be limited by examples provided herein. It is further intended that the attached claims be read broadly in light of the teachings provided herein. Where specific examples are described in detail, no inference should be drawn to exclude other examples or to exclude examples described or mentioned briefly from the broad descriptions of the invention provided herein. It is therefore intended that the invention not be limited except as provided in the attached claims and equivalents thereof.

Further Example System Overview

In a further specific embodiment, the present invention relies on one or more retargetter systems or retargetter functions to manage distribution of content from publishers to CDNs systems and to redirect viewer content requests to appropriate CDNs or CDN source.

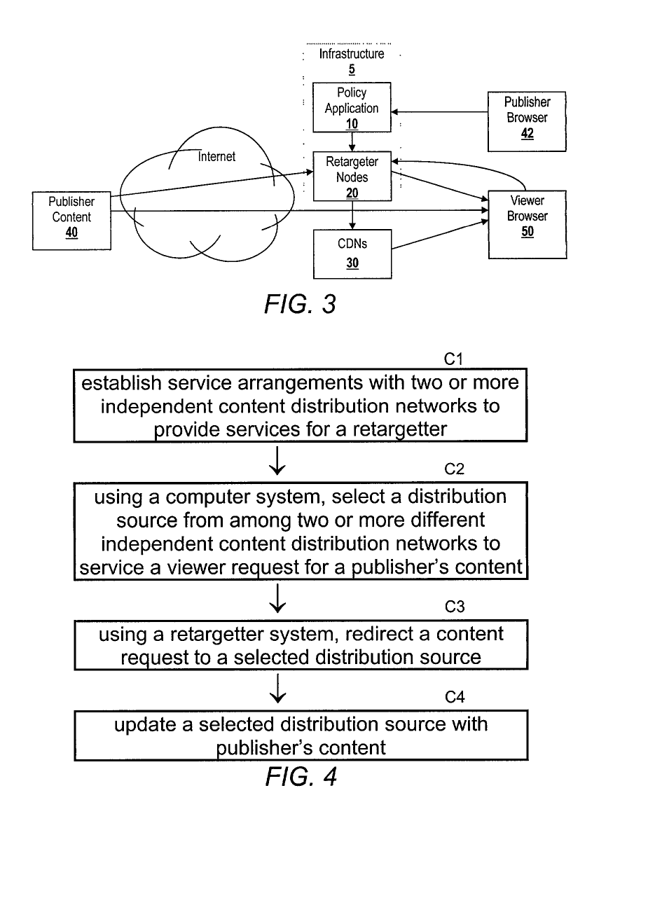

In a particular embodiment, various aspects of the invention are included in a dynamic content distribution management service that can instantly accelerate the content of any web site. FIG. 3 is a block diagram showing a system operating according to a specific embodiment of the invention. This embodiment comprises a web-based application 10 that accepts desired operating parameters such as publisher acceleration policies, viewer performance data, etc. This information is provided in real-time to a set of distributed retargetters 20. These retargetters provide real-time rerouting of HTML pages (or other standard content format pages that may include locators, such as MS Word, VRML, RTML, etc.) to connect content 40 from a publisher's servers to the most desirable (such as that having the fastest response time or the least cost) content distribution network (CDN) 30 as determined either wholly or in part by each individual viewer.

In specific embodiments, real-time rerouting involves modifying content pages based on the acceleration policies set by the publisher and the real-time performance information. A conceptual diagram of this service is shown in FIG. 3. Requests for accelerated content pages are submitted to the retargetter, which then instructs the browser to obtain items from the retargetter, the publisher, or the “best” CDN.

A system as shown in FIG. 3 can accelerate a publisher's website in several ways. One example desirable method requires no DNS changes. An example detailed method, including a number of optional steps, works as follows: (1) The publisher opens his browser 42 and logs onto a policy application website. (2) The publisher then uses his browser to define an acceleration policy and (3) adds or modifies the publisher's home page redirecting viewer browsers to a retargetter. (4) In specific embodiments, a retargetter of retargetter nodes 20 provides the viewer's browser with performance measurement code that (5) contains a list of CDNs and/or CDN sources to be tested. (6) The viewer's browser measures response times from the supported CDNs and (7) reports this information back to the retargetter and the policy application server. (8) The retargetter retrieves content (such as HTML content) from publisher's servers, (9) modifies the content's URLs (or similar locators) in real-time based on the programmed policies and/or the measured performance information, (10) delivers the modified content to the browser, and (11) optionally caches in a local retargetter cache the modified HTML if applicable. (12) The viewers then retrieve the data from the locations indicated by the modified locators, which can indicate: a content server 40, one of retargetters 20, and/or one or more selected CDNs 30.

It will be understood from the teachings herein that the invention according to various embodiments can provide advantageous in various embodiments of the general system as shown in FIG. 3. These advantageous comprise various combinations of the following:

Viewer can receive data from fastest responding CDN (or CDN source) allowed under specified policies, regardless of CDN sources owned and managed by separate CDNs.

Because of the centralized role of the retargetters, it is possible to provide detailed unified usage reporting and analysis to publishers, even when using different CDN systems.

Because of the centralized role of the retargetters, it is also possible to centrally handle billing and service initiation, even when using different CDN systems.

No web site pre-processing is required by publishers before publishing content to acceleration service.

Acceleration policies can be updated instantly.

Access to various CDNs can be initiated instantly.

DNS changes are optional.

No software requiring user intervention is necessary to install.

Content within dynamic pages can be accelerated because the HTML code from the publisher is modified in real-time, en route to the viewer.

No changes required at the publisher site to applications that generate dynamic HTML pages.

Furthermore, using an executable code component at a viewer computer, an original URL look and feel can be presented to viewers.

Initial Redirection

In alternative embodiments, the invention may employ different methods for performing the initial redirection to a retargetter node. As examples, two methods that are sometimes used in the art may be employed according to the specific embodiments are listed in Table 3, along with some of their benefits and drawbacks.

TABLE 3
Existing General Methods for Redirection and Masking URLs

| METHOD | BENEFITS | DRAWBACKS |
|---|---|---|
| (INVISIBLE) | Easy to setup; | Browsers are only |
| FRAME | Maintains site's URL look and | able to bookmark |
| REDIRECTION | feel; | the site's home |
| | No DNS changes required; | page |
| | Acceleration can be initiated is | |
| | controlled by a single web page | |
| | on original site; | |
| DNS CHANGE | URLs look very similar to | Requires a DNS |
| | original site; | change; |
| | Browsers can bookmark any page | |
| | within the site; | |

Publisher Convenience

In particular embodiments, initiation of acceleration service can involve placing just two files on the publisher's web site: an HTML file that redirects the browser request to the acceleration infrastructure and kicks off the acceleration process; and a small test file (such as a fasttide.gif image file) used in performance testing for selection of the preferred FastTide region and Content Distribution Network.

In a further embodiment, a publisher can initially use frame-based acceleration to accelerate a site without delegation of a domain. This method utilizes a browser frame to hide from the viewer's display the domain name generated by the acceleration system. This method provides an easy way for publishers to try out the acceleration service. Once a publisher has determined that they want a more permanent acceleration service, a subdomain-based acceleration method can be used to accelerate a site using a subdomain delegated to the acceleration services by the publisher. Use of this method allows for easier and proper handling of cookies and deep bookmarks. There are two forms of this method. One in which a redirection page is required. The other does not require a redirection page; any request to the site is directed to the acceleration infrastructure.

Detailed Example Method for Acceleration According to Specific Embodiments

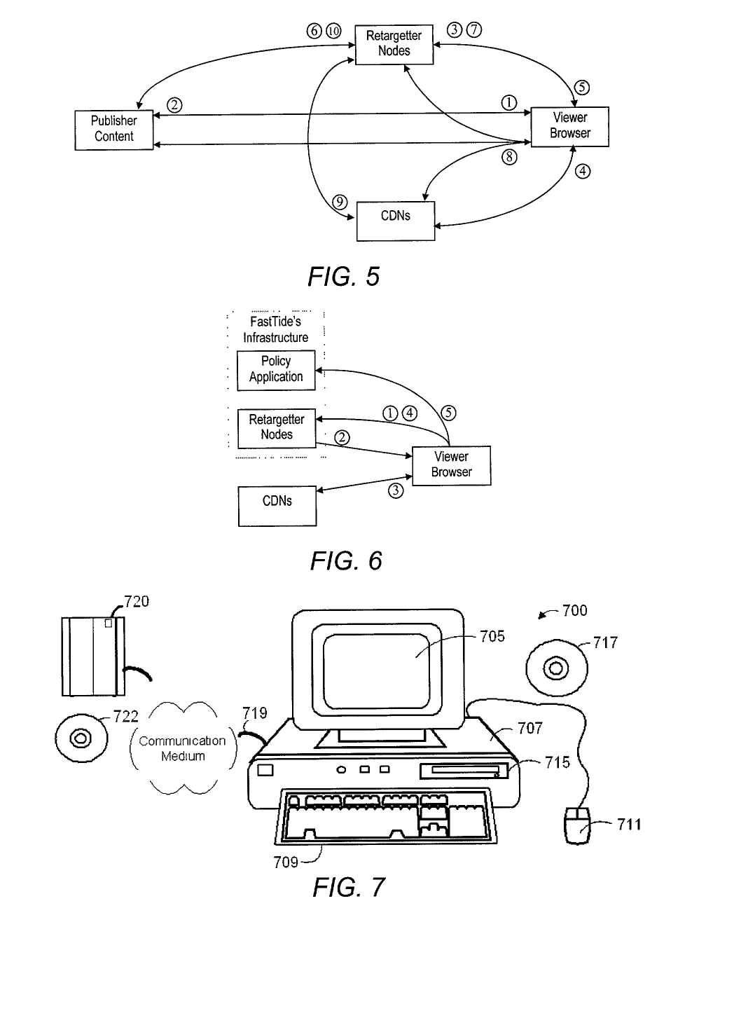

FIG. 5 shows the steps involved in accelerating a site according to one example method according to specific embodiments of the present invention. Details of these interactions in this example are listed below. The circles on the flow arrows are placed near the source of the packet data described in the correspondingly numbered step.

1. A viewer's browser contacts a publisher's content server.

2. The publisher's server redirects the viewer to retargetter nodes. This can be accomplished using a variety of initial redirection methods as described herein. Further, according to specific embodiments of the present invention, a DNS resolver can optionally pick a retargetter closest to the browser and direct the browser to that particular retargetter. Thus, it will be understood that in typical embodiments, retargetter nodes 20 can include a number of retargetter nodes distributed throughout a communication network.

3. In specific embodiments, a retargetter provides initial code to the viewer browser directing the browser to participate in selecting a cache source.

4. According to specific embodiments of the present invention, the viewer's browser measures response times to one or more supported CDNs. As will be understood from the teachings herein, response time is generally measured to a CDN system as a whole. Where allowed by a CDN system, response times can also be measured to devices within a CDN system.

5. According to specific embodiments of the present invention, performance information is returned to the retargetter by the viewer browser. A cache source is selected, which according to specific embodiments can be selected by the viewer browser or by the retargetter using information from the viewer browser. The selected cache source in various embodiments can be a cache source device owned and managed by the retargetter nodes; one or more outside CDNs; or the retargetter itself.

6. The retargetter retrieves a requested HTML page (or other content containing resource locators) from the publisher's web site (or from the retargetter's local cache storage if it is available and fresh.)

7. The retargetter modifies appropriate contained URLs based on established acceleration policies and based on the selected CDN source and optionally caches the modified HTML pages. The retargetter then returns a modified page to the browser.

8. The browser retrieves content indicated by the URLs, some of which may have been translated by the retargetter. These translated URLs can indicate data from one or more selected CDNs, from the retargetter, or from the publisher's site, or from external data sources. Optionally, URLs indicating external data may be untranslated by the retargetter.

9. A content delivery network will, in turn, request pages and/or embedded content it does not already have from the retargetter. This may be done in accordance with a variety of CDN operating procedures, where, as far as the CDN is concerned the retargetter is the publisher.

Thus, in one embodiment, a CDN never communicates directly with a publisher site. 10. A retargetter will in turn request pages and embedded data it does not have from the publisher's servers, and then provide those pages or embedded data to the CDN.

Note that in this method, the publisher needs no information about particular CDN components to which viewers are directed and may in fact be wholly unaware of which CDNs are being used to accelerate publisher content. Likewise, a CDN may never communicate with the publisher site and may view the retargetter as the original source for publisher. A retargetter, according to the invention, may therefore both technically and/or from a business perspective, act as an intermediary, managing policy distribution, payment, and client access to a variety of CDNs on behalf of one or more publishers. This allows publishers to achieve a maximum acceleration based on a variety of available CDNs, without entering into numerous complex business arrangements and without keeping track of possible incompatible management interfaces with different CDN nodes. Thus in specific embodiments according to the invention, various aspects of the invention allow a system to manage CDN services from competing CDN sources on the fly and provide acceleration to web pages. In further embodiments, this further enables centralized payment, selection, and other functions provided by the retargetter.

Example Detailed Description of URL Translations According to Specific Embodiments

The following is a description of the URLs displayed in Table 4 with respect to the steps being performed:

1. The viewer's browser contacts the publisher's content server at the publisher's normal URL (e.g. www.pub.com).

2. The publisher's server redirects the viewer to retargetters via techniques such as URL translation (e.g. fast.fasttide.com/www.pub.com/ . . . ) or via a DNS name change to a name delegated to the retargetters by the publisher, e.g. wwwl.pub.com. In further embodiments, a DNS resolver may pick a retargetter closest to the browser and direct the browser to that particular retargetter, as would be understood in the art. In particular embodiments, the retargetter may provide the viewer's browser a page that contains performance measurement code, e.g. test_cdns.html.

In particular embodiments, the viewer's browser may measure response times to the supported CDNs using the URLs shown for step 4. There can be different forms of the request depending upon whether the CDN itself is a DNS-based or directory-based CDN. In various embodiments, performance information can be returned to the retargetter to aid in selecting an optimal CDN, or a CDN can be selected by the viewer.

5. A selected CDN can be indicated using different translations in different forms of URL, as shown in step 5.

6, 10. The retargetter retrieves the requested HTML page from the publisher's web site.

7. The retargetter modifies contained URLs (using HTMLRouting) indicating embedded content based on the acceleration policy and selected CDN. The retargetter optionally may cache the modified HTML pages. URLs to other HTML pages are redirected to the retargetter, indicating the previously selected cache source (e.g. fast.fasttide.com/www.pub.com/cdnx/ . . . OR cdnx.fast.fasttide.com/www.pub.com/cdnx/ . . . OR wwwl.pub.com/cdnx/ . . . ). Generally, external links are unchanged. URLs to embedded content supported or accelerated by the retargetter or the CDNs are changed to an appropriately formatted URLs for the particular cache source. The retargetter returns the modified pages to the browser.

8. The browser retrieves subsequent URLs based on the modified pages. These URLs may indicate the selected content delivery network, the retargetter, the publisher's site, and/or external locations. Note that URLs of the form fasttide.cdnx.com/www.pub.com/ . . . are hosted at the CDN site and are generally “owned” by the CDN. The exact format of URLs to a particular CDN can vary based on the requirements of the different CDNs and a retargetter according to the present invention can comply with a variety of CDN specified URL formats. As an example, the actual URL provided as a redirect to embedded content at the zoomzoom CDN might have the form www.zoomzoom.net/www.fasttide.com/pub.com/ . . .

9. The content delivery networks may in turn request pages they do not already have from the retargetter.

10. The retargetters may in turn request pages they do not already have from the publisher's servers.

Table 4 displays sample incoming and outgoing link translations for each type of source and relates those translations to the steps shown in FIG. 5. Various types of CDN translation links can be supported according to further embodiments of the invention. As an example, there are two types of commonly used translation links, as will be generally understood in the art: DNS-based and directory-based.

With a directory-based translation, the CDN path and any CDN directory structure is indicated in the translated URL, along with an indication of the URL of the original data. This translation can be in different forms, such as, for example fast.fasttide.com/www.publisher.com/cdnx/ . . . or cdnx.fast.fasttide.com/www.publisher.com/ . . . . With DNS-based translation, the DNS name of the original server is replaced with a DNS name indicating the CDN. Both of these types of CDN links are shown in the table and can be supported according to the invention. A retargetter according to specific embodiments of the invention, can dynamically support both types of CDN and other CDNs and dynamically deliver translated URL pages appropriate for a particular selected CDN.

As discussed above, the initial redirection can be accomplished either through a frame-based translation/redirection or through redirection using DNS acceleration. With the DNS acceleration, the publisher website delegates a sub-domain to a central content manager. In the table below, for example, wwwl.pub.com has been delegated by the publisher to a retargetter address, (such as FastTide).

TABLE 4
EXAMPLE URLS TRANSLATION

| SOURCE/ | | | |
|---|---|---|---|
| DESTINATION (I.E. | | | |
| NETWORK | | | |
| ELEMENT | | DIRECTION | |
| involved) | STEP | (COMMENT) | URLS |
| PUBLISHER | 1 | In from Browser | www.pub.com |
| | 2 | Out to Browser (initial | |
| | | redirect to retargetter) | |
| | | Retargetter via | fast.fasttide.com/www.pub.com/test_cdns.html |
| | | URL translation | |
| | | Retargetter via | wwwl.pub.com/home.html |
| | | DNS change | |
| RETARGETTER | 5 | In from Browser | |
| (in this example | | (selecting cdnx as cache | |
| named FastTide) | | source) | |
| | | Retargetter via | fast.fasttide.com/www.pub.com/cdnx/... OR |
| | | URL Translation | cdnx.fasttide.com/www.pub.com/... |
| | | | This second form is more compatible with |
| | | | some JAVA components. |
| | | Retargetter via | wwwl.pub.com/cdnx/... OR |
| | | DNS change | cdnx.wwwl.pub.com/... |
| | 6,10 | Out to Publisher | www.pub.com/... |
| | 6,10 | In from Publisher | www.pub.com/... |
| | 7 | Out to Browser (to html | |
| | | content) | |
| | | Retargetter via | fast.fasttide.com/www.pub.com/cdnx/... OR |
| | | URL Translation | cdnx.fast.fasttide.com/www.pub.com/... |
| | | Retargetter via | wwwl.pub.com/cdnx/... |
| | | DNS change | |
| | 7 | Out to Browser (to | Unchanged |
| | | external links) | |
| | 7 | Out to Browser (to | fast.fasttide.com/www.pub.com/... |
| | | embedded content, | |
| | | selected Cache Source is | |
| | | Retargetter) | |
| | 7 | Out to Browser (to | fasttide.cdnx.com/fast.fasttide.com/www.pub.com/... |
| | | embedded content, | |
| | | selected Cache Source is | |
| | | CDNx-dir) | |
| | 7 | Out to Browser (to | cdnx fasttide.com/www.pub.com/... |
| | | embedded content, | |
| | | selected Cache Source is | |
| | | CDNx-dns) | |
| CDNX-DIR | 4,8 | In from Browser | cdnx fasttide.comfast.fasttide.com/www.pub.com/... |
| | 9 | Out to Retargetter | fast.fasttide.com/www.pub.com/... |
| | 9 | In from Retargetter | no further urls |
| | ... | Out to Browser | no further urls |
| CDNX-DNS | 4,8 | In from Browser | fasttide.cdnx.com/www.pub.com/... |
| | 9 | Out to Retargetter | fast.fasttide.com/www.pub.com/... |
| | 9 | In from Retargetter | no further urls |
| | ... | Out to Browser | no further urls |

As will be understood from the teachings herein to practitioners in the art, real-time HTML routing may be used to optimize such things as: CDN Performance; Bandwidth costs; Data freshness; Allocation of time-of-day bandwidth; Selection of data types per CDN; CDN Availability; etc.

Performance Measures

In specific embodiments, real-time performance measurements are used to determine which CDN is performing the best for each given viewer and data is retargetted to the CDN with the best performance. Many different performance selection criteria can be used. A simple method measures only the current session's performance. A more sophisticated method performs a weighted averaging including the results of previous performance measurements and/or performs a statistical predictive analysis. The performance statistics are gathered and analyzed to provide publishers with performance reports. Selection can also include cost or other factors.

FIG. 6 displays how the real-time performance measurements are accomplished according to one embodiment. These steps are listed below:

1. After the publisher redirects the viewer to the retargetter location, the browser requests a CDN-neutral URL. The retargetter determines that the viewer's browser has not selected a CDN based on the requested URL.

2. The retargetter sends the CDN performance measurement and selection code to the browser. This code can be delivered to the viewer using one of several methods. These include JavaScript, Java applets, COM files, and/or plug-ins, etc.

3. The browser runs the code and performs the response time measurements.

4. The browser reports the results to the retargetter through a predefined, CDN-specific URL mapping. In other words, in particular embodiments, the browser indicates a selected CDN by requesting from the retargetter a URL including data indicating that CDN.

5. The browser in specific embodiments may also transmit the results of the performance measurements to the retargetter for further analysis and reporting.

If a CDN's charges are based on 95% bandwidth, real-time measurements can be used to determine CDN loads and more traffic can be routed to CDNs that are lightly loaded. This process allows the retargetter to optimize its costs, which can be passed on as savings to its customers. In further embodiments, the retargetter can manage maximum cache expiry times and other caching parameters to ensure freshness of the publisher's content. In further embodiments, customers (e.g. publishers) may schedule bandwidth on demand for promotional events. In other embodiments, different data types may be routed to different CDNs depending upon the capabilities of those CDNs. As another advantage according to the invention, customers are automatically routed to other CDNs if a CDN becomes unavailable or unreachable for some reason.

In one specific embodiment, performance can be measured by requesting a small file located at the publisher site from multiple CDNs and selecting the fastest responding CDN. Generally, the response to request time is the primary bottleneck for CDN performance, rather than the time to transmit the data once a session has been established. In experimental tests, it has been found that the CDN the responds the quickest in the initial request tests provides the best performance approximately 85% of the time. In a further embodiment, a selection method can utilize the historical running average to select the best CDN for a particular viewer session, which has been found to correlate very highly with the best actual CDN in terms of performance.

Communication Network Selection

In a further specific embodiment, the present invention relies on one or more retargetter systems or functions to manage distribution of content from publishers directly to viewers on one or more communication networks and to redirect viewer content requests to the appropriate communications network. In this embodiment, for the purposes of CDN selection and performance measuring, the retargetter infrastructure can be considered another CDN to be tested. When a retargetter is selected, or when the retargetter is serving content that is not being accelerated by the CDNs, the retargetter acts as a communications network switching point. The retargetters are placed in networks such that they have direct connectivity and routes to major backbones on the Internet. The routing tables in routers connecting the retargetter are constructed in such a way that a vast majority of viewers trying to reach the retargetter traverses only one Internet backbone. Additionally, the retargetter is usually only one Internet backbone away from a vast majority of publisher sites. With this routing arrangement, the retargetter acts as an Internet backbone switch, moving the content from the publisher's backbone to the viewer's backbone through private links between the backbones.

### Embodiment in a Programmed Information Appliance

FIG. 7 is a block diagram showing a representative example logic device in which various aspects of the present invention may be embodied. As will be understood to practitioners in the art from the teachings provided herein, the invention can be implemented in hardware and/or software. In some embodiments of the invention, different aspects of the invention can be implemented in either client-side logic or server-side logic. As will be understood in the art, the invention or components thereof may be embodied in a fixed media program component containing logic instructions and/or data that when loaded into an appropriately configured computing device cause that device to perform according to the invention. As will be understood in the art, a fixed media containing logic instructions may be delivered to a viewer on a fixed media for physically loading into a viewer's computer or a fixed media containing logic instructions may reside on a remote server that a viewer accesses through a communication medium in order to download a program component.

FIG. 7 shows an information appliance (or digital device) 700 that may be understood as a logical apparatus that can read instructions from media 717 and/or network port 719, which can optionally be connected to server 720 having fixed media 722. Apparatus 700 can thereafter use those instructions to direct server or client logic, as understood in the art, to embody aspects of the invention. One type of logical apparatus that may embody the invention is a computer system as illustrated in 700, containing CPU 707, optional input devices 709 and 711, disk drives 715 and optional monitor 705. Fixed media 717, or fixed media 722 over port 719, may be used to program such a system and may represent a disk-type optical or magnetic media, magnetic tape, solid state dynamic or static memory, etc. In specific embodiments, the invention may be embodied in whole or in part as software recorded on this fixed media. Communication port 719 may also be used to initially receive instructions that are used to program such a system and may represent any type of communication connection.

The invention also may be embodied in whole or in part within the circuitry of an application specific integrated circuit (ASIC) or a programmable logic device (PLD). In such a case, the invention may be embodied in a computer understandable descriptor language, which may be used to create an ASIC, or PLD that operates as herein described.

Other Embodiments

The invention has now been described with reference to specific embodiments. Other embodiments will be apparent to those of skill in the art. In particular, a viewer digital information appliance has generally been illustrated as a personal computer. However, the digital computing device is meant to be any information appliance for interacting with a remote data application, and could include such devices as a digitally enabled television, cell phone, personal digital assistant, etc.

In addition, channels have been described primarily as traditional network connections, with the appropriate corresponding hardware. However, channels are meant to be any channels capable of carrying data, including wireless channels, optical channels, and electrical channels.

It is understood that the examples and embodiments described herein are for illustrative purposes and that various modifications or changes in light thereof will be suggested by the teachings herein to persons skilled in the art and are to be included within the spirit and purview of this application and scope of the claims.

All publications, patents, and patent applications cited herein are incorporated by reference in their entirety for all purposes.

What is claimed:

1. A method of providing content to a viewer comprising:
performing an initial redirection to a retargetter system, said retargetter system thereafter being the source to a viewer of content containing resource locators;
performing second redirections at said retargetter system to one or more cache sources, said cache sources thereby becoming sources to a viewer of embedded content.

2. The method according to claim 1 wherein said second redirections can indicate sources in two or more independently managed content distribution networks.

3. The method according to claim 1 wherein said second redirections can indicate sources in two or more independently managed content distribution networks and wherein said second redirections can be formatted to comply with different redirection schemes of said two or more independently managed content distribution networks.

4. The method according to claim 1 wherein said initial redirection is performed at a publisher website in response to an initial viewer request to access publisher content.

5. The method according to claim 1 wherein said initial redirection is selected from the group consisting of:
resetting a domain name for said publisher to said retargetter node; and
performing a frame redirection at said publisher site to said retargetter system.

6. The method according to claim 1 wherein said second redirection is accomplished by dynamically modifying resource locators in said content.

7. The method according to claim 6 wherein dynamically modified resource locators can be modified for particular cache sources in accordance with either directory-based content distribution network file mapping or DNS-based content distribution network file mapping, as appropriate for a particular cache source.

8. The method according to claim 1 further comprising:
at said retargetter system, providing instructions for said client to select one from a plurality of cache sources; and
at said retargetter system, receiving data indications from a viewer indicating a selected cache source.

9. The method according to claim 1 further comprising:
at said retargetter system, providing instructions for a client to measure response times to a plurality of cache sources; and
at said retargetter system, receiving data indications from a viewer indicating results of response time measurements.

10. The method according to claim 9 further comprising:
at said retargetter system, providing candidate cache sources to a client.

11. The method according to claim 9 wherein said results indicate a cache source selected by a viewer system.

12. The method according to claim 9 wherein said cache sources comprise at least two independently managed cache sources.

13. The method according to claim 9 wherein said cache sources comprise at least two independently managed cache sources having at least two different file mapping protocols.

14. The method according to claim 9 wherein said cache sources comprise at least one independently managed cache source and said retargetter system acting as a cache source.

15. The method according to claim 9 wherein said instructions comprise executable code for measuring response times at said viewer.

16. The method according to claim 1 wherein said second redirections further comprise:
modifying resource locators indicating HTML files or other files that may contain resource locators to indicate said retargetter as the delivery source of said pages;
modifying resource locators indicating content that cannot contain further resource locators to indicate said selected cache source as the delivery source of said embedded content and said retargetter as the publisher of said content.

17. The method according to claim 1 further comprising:
caching a page with modified resource locators indicating a selected cache source;
when receiving a second request for said page, said second request further indicating the same selected cache source, returning a cached page.

18. A method of providing accelerated content to a viewer comprising:
upon receiving a request for a publisher page:
dynamically translating resource locators of content that can contain further resource locators to indicate an intermediate node as a source for said content;
dynamically translating resource locators of embedded content that can not contain further resource locators to indicate a selected content distribution network; and
providing a requested page with translated resource locators indicating an intermediate node and a content source for content in said page.

19. The method according to claim 18 wherein a translated resource locator of embedded content includes indications of said selected content distribution network, said intermediate node, and an original publisher of said content.

20. The method according to claim 19 wherein said translated resource locator includes indications for said intermediate node such that a content distribution network will treat said intermediate node an original publisher of said content.

21. The method according to claim 18 wherein said selected content distribution network can be one of two or more independently managed content distribution networks.

22. The method according to claim 18 wherein resource locators can be dynamically translating to comply with different redirection schemes of two or more independently managed content distribution networks.

23. The method according to claim 18 wherein resource locators are translating at said intermediate node in real time while forwarding publisher content to a viewer.

24. The method according to claim 18 wherein resource locators in dynamically generated publisher content are translating at said intermediate node in real time while forwarding said publisher content to a viewer.

25. The method according to claim 18 wherein a translated resource locator to content that can include further resource locators has the general form:
intermediate_node_URL/publisher_indication/selected_cdn_indication/original_content_path.

26. A method of content delivery over a network comprising:
receiving a viewer request at a publisher to access content;
redirecting said viewer request to a retargetter;
receiving performance data from one or more distribution sources;
determining a distribution source from which distributed content will be served;
in real time, modifying one or more content locators referenced by said content to indicate said distribution source; and
serving said content to said viewer.

27. The method according to claim 26 further comprising:
at said retargetter, receiving acceleration policy indications from a publisher and implementing said acceleration policy indications.

28. The method according to claim 26 wherein said content is formatted in a protocol with standard universal resource locators (URLs).

29. The method according to claim 26 further comprising including an executable portion in content delivered to a viewer, said executable portion capable of modifying a location identifier displayed at a viewer.

30. A method of content delivery over a network comprising:
at a publisher network location, receiving a viewer request to access content;
redirecting said viewer request to a retargetter;
determining a distribution source from which distributed content will be served;
at said retargetter, retrieving publisher pages containing resource locators;
at said retargetter, providing a viewer said publisher pages, with resource locators translated to indicate embedded content from a determined distribution source; and
at said retargetter, responding to requests from said determined distribution source for embedded content by retrieving said embedded content and transmitting it to said determined distribution source.

31. A fixed media containing logical instructions that when loaded into an appropriately configured digital apparatus causes the apparatus to operate in accordance with the method of claim 1.

32. A content acceleration system comprising:
a plurality of retargetter nodes, said retargetter nodes comprising:
network communication connections with a plurality of content distribution networks;
network communication connections with publisher content; and
network communication connections with a viewer browser.

33. The system to claim 32 further wherein said retargetter nodes are the source for all publisher content requested by a content distribution network.
